(19) United States
(12) Patent Application Publication
(10) Pub. No.: US 2023/0130033 A1
(43) Pub. Date: Apr. 27, 2023

(54) METHOD AND CATALYST ARTICLE

(71) Applicant: Johnson Matthey Catalysts (Germany) GmbH, Redwitz an der Rodach (DE)

(72) Inventors: Juergen BAUER, Redwitz (DE); Sofia LOPEZ-OROZCO, Redwitz (DE)

(21) Appl. No.: 18/048,509

(22) Filed: Oct. 21, 2022

(30) Foreign Application Priority Data
Oct. 22, 2021 (EP) 21204187.5

(51) Int. Cl. B01J 29/76; B01J 29/70; B01J 37/00

(52) U.S. Cl. CPC B01J 29/76; B01J 29/7015; B01J 37/0018; B01J 2229/18; B01J 2229/20; B01J 2229/42

(57) ABSTRACT

The present disclosure relates to a method for forming a catalyst article comprising: (a) forming a plastic mixture having a solids content of greater than 50 % by weight by mixing together a crystalline small pore molecular sieve in an H⁺ or NH₄⁺ form, iron sulphate, an inorganic matrix component, an organic auxiliary agent, an aqueous solvent and optionally inorganic fibres; (b) moulding the plastic mixture into a shaped article; and (c) calcining the shaped article to form a solid catalyst body. The present disclosure further relates to a catalyst article, an exhaust system, and a method of treating an exhaust gas.

### FIELD OF THE INVENTION

The present disclosure relates to a method for forming a catalyst article comprising an iron-loaded small pore molecular sieve. In particular, the present invention relates to a method for forming an extruded catalyst article suitable for use in the selective catalytic reduction of nitrogen oxides (NOx) in an exhaust gas. The present disclosure further relates to a catalyst article, an exhaust system and a method of treating an exhaust gas.

### BACKGROUND OF THE INVENTION

Large numbers of catalytic converters used for the treatment of emissions from mobile and stationary sources are manufactured each year. Catalytic converters for use in motor-vehicles typically comprise an extruded ceramic honeycomb monolith that is provided with channels for the through-flow of exhaust gases. The channels of the monolith may be coated with a catalytically active material (known as a “washcoat”). Alternatively, the extruded monolith itself is formed of a catalytically active material (referred to as an “all-active extrudate” or “extruded catalyst”).

To produce an all-active extrudate, the catalytically active component is included in an extrusion composition whose rheological properties have been set so as to be suitable for the extrusion process. This extrusion composition is a plastic (i.e. easily shaped or mouldable), viscous composition. To set the desired rheological properties of the extrusion composition and also the mechanical properties of the extrudate, binders or additives are typically added to the extrusion composition. This plastic composition is then subjected to an extrusion process for preparing, for example, a honeycomb body. The so-called “green” body thus obtained is then subjected to a high temperature calcination treatment to form the finished extruded catalyst body.

All-active extrudates generally comprise a unitary structure in the form of a honeycomb having uniform-sized and parallel channels extending from a first end to a second end thereof. Generally, the channels are open at both the first and second ends - a so-called “flow through” configuration. Alternatively, channels at a first, upstream end can be plugged, e.g. with a suitable ceramic cement, and channels not plugged at the first, upstream end can also be plugged at a second, downstream end to form a so-called wall-flow filter.

The selective catalytic reduction of nitrogen oxides (NOx) by ammonia (NH₃—SCR) is considered to be the most practical and efficient technology for the abatement of NOₓ from exhaust gases emitted from stationary sources and mobile engines, principally diesel engines for vehicles such as automobiles, trucks, locomotives and ships.

Known SCR (selective catalytic reduction) catalysts include vanadium based catalysts and molecular sieves. Useful molecular sieves include crystalline or quasi-crystalline materials which can be, for example aluminosilicates (zeolites) or silicoaluminophosphates (SAPOs). Such molecular sieves are constructed of repeating SiO₄, AlO₄, and optionally PO₄ tetrahedral units linked together, for example in rings, to form frameworks having regular intra-crystalline cavities and channels of molecular dimensions. The specific arrangement of tetrahedral units (ring members) gives rise to the molecular sieve’s framework, and by convention, each unique framework is assigned a unique three-letter code (e.g., “CHA”) by the International Zeolite Association (IZA). Examples of molecular sieve frameworks that are known SCR catalysts include Framework Type Codes CHA (chabazite), BEA (beta), MOR (mordenite), AEI, MFI and LTA.

Molecular sieves (e.g. zeolites) may also be categorised by pore size, e.g. a maximum number of tetrahedral atoms present in a molecular sieve’s framework. As defined herein, a “small pore” molecular sieve, such as CHA, contains a maximum ring size of eight tetrahedral atoms, whereas a “medium pore” molecular sieve, e.g. MFI, contains a maximum ring size of ten tetrahedral atoms; and a “large pore” molecular sieve, such as BEA, contains a maximum ring size of twelve tetrahedral atoms. Small and medium pore molecular sieves, especially small pore molecular sieves, are preferred for use in SCR catalysts, since they may, for example, provide improved SCR performance and/or improved hydrocarbon tolerance.

Molecular sieve catalysts may be metal-promoted. Examples of metal-promoted molecular sieve catalysts include iron-, copper- and palladium-promoted molecular sieve, where the metal may be loaded into the molecular sieve. In a metal-loaded molecular sieve, the loaded metal is a type of “extra-framework metal”, that is, a metal that resides within the molecular sieve and/or on at least a portion of the molecular sieve surface and does not include atoms constituting the framework of the molecular sieve.

Certain iron- and copper-loaded small and medium pore zeolites are known to demonstrate high catalytic activity in selective catalytic reduction of nitric oxide and/or nitrogen dioxide by ammonia (NH₃—SCR) and have been extensively investigated. It is known that relatively good low temperature (200-450° C.) NH₃—SCR catalytic activity can be obtained from Cu-SSZ-13 (CHA) zeolites (see e.g. International patent publication no. WO2008/132452 A2). However, in general, Fe-loaded zeolites exhibit better higher temperature catalytic activity than Cu-containing zeolites and so Fe-loaded zeolites are of particular interest for NH₃—SCR applications. Moreover, the use of Cu-containing zeolites can lead to formation of N₂O at higher reaction temperatures.

Several methods have been mentioned in the literature for preparing Fe-loaded zeolites. The direct synthesis of iron-loaded zeolites is a complicated process and depends on the synthesis conditions (see M. Moliner, ISRN Materials Science, 2012, Article ID 789525). An alternative is to use a commercial zeolite support and subsequently to add iron by post-synthesis treatment of the zeolite either by wet impregnation, wet ion exchange or solid-state ion exchange.

Known wet ion-exchange methods for the addition of iron to molecular sieves typically employ iron salts, such as iron acetate, as the active metal precursor, wherein the active metal precursor is reacted with the molecular sieve in aqueous solution. In order to accelerate ion-exchange, such processes typically require a heating step, wherein the mixture may be heated to a temperature in the range 70 to 80° C. for up to several hours. Further, additional processing steps (e.g. filtering, evaporation, spray-drying, calcination etc) may be required before the resulting metal-loaded molecular sieve may be employed in an extrusion paste for the formation of an all-active extrudate.

Furthermore, a problem associated with the preparation of Fe-loaded zeolites by post-synthesis treatment is the aggregation of iron species, which leads to an inhomogeneous distribution of iron species in the zeolite (see e.g. L. Kustov et al., Topics in Catalysis, 238 (2006) pp. 250-259).

WO2020/148186 describes a method of forming iron-loaded zeolite which requires (i) treatment of zeolite crystallites to introduce mesoporosity, (ii) introduction of the metal into the product of (i) via wet impregnation or wet ion-exchange; and (iii) performing hydrothermal crystallisation on the product of (ii).

The present invention provides an improved process for the preparation of extruded catalyst articles which employ an iron-loaded small pore molecular sieve as a catalytically active material.

According to a first aspect of the present disclosure there is provided a method for forming a catalyst article comprising:
(a) forming a plastic mixture by mixing together at least the following components:
   (i) a crystalline small pore molecular sieve in an H⁺ or NH₄⁺ form;
   (ii) iron sulphate;
   (iii) an inorganic matrix component;
   (iv) an organic auxiliary agent;
   (v) an aqueous solvent;
   wherein the mixture has a solids content of greater than 50% by weight (based on the total weight of the mixture);
(b) moulding the plastic mixture into a shaped article; and
(c) calcining the shaped article to produce a solid catalyst body and wherein step (a) is carried out at a temperature in the range 10 to 35° C.

Advantageously, it has been found that the heat employed to calcine the shaped article may be exploited to promote iron loading onto the molecular sieve. Thus, the requirement for any heating steps during wet ion-exchange or impregnation processes and the requirement for expensive, high-temperature-resistant equipment may be avoided. Further, long reaction times typical in wet ion-exchange or impregnation processes and/or energy and labour-intensive processes such as spray-drying may be avoided. Consequently, the method according to the first aspect may be more energy efficient and economical.

Furthermore, it has been found that the mixture prepared in step (a) of the method according to the first aspect, may be employed directly as an extrusion paste without the need for any further processing steps. In particular, the method of the first aspect may reduce the overall water consumption in the manufacture of extruded catalysts comprising iron-loaded small pore molecular sieves, since it is conventional to employ powdered forms of pre-loaded small pore molecular sieves, which themselves were prepared via a wet process followed by drying and/or calcination.

Advantageously, it has been found that catalysts prepared according to the first aspect may provide comparable NOx conversion to catalysts prepared in a similar manner using copper salts and provide improved NOx conversion compared to vanadium-based SCR catalysts, and in both cases provide significantly improved N₂O selectivity at high temperatures. Moreover, it has surprisingly been found that catalysts prepared according to the first aspect may have improved thermal expansion properties.

According to a second aspect of the present disclosure, there is provided a catalyst article obtained or obtainable according to the method of the first aspect.

According to a third aspect of the present disclosure, there is provided a catalyst article comprising an extruded solid catalyst body, which solid catalyst body comprises an iron-loaded small pore molecular sieve and has a coefficient of thermal expansion (CTE) which is ≥ 0 at a temperature in the range 100° C. to 700° C. Preferably, the catalyst article has a CTE in the range 0 to 5 × 10⁻⁶ /K, for example 0.5 × 10⁻⁶ /K to 4 × 10⁻⁶ /K, at a temperature in the range 100° C. to 700° C.

According to a fourth aspect of the present disclosure, there is provided an exhaust system comprising: a source of nitrogenous reductant and an injector for injecting a nitrogenous reductant into a flowing exhaust gas, wherein the injector is disposed upstream from a catalyst article according to the second or third aspects.

According to a fifth aspect of the present disclosure, there is provided a method of treating an exhaust gas, comprising contacting the exhaust gas with a catalyst according to the second or third aspects. Preferably, the exhaust gas has a temperature in the range 300 to 600° C., more preferably 350 to 550° C., for example 400 to 500° C. The exhaust gas may be derived from a stationary source.

According to a sixth aspect, there is provided the use of a catalyst article according to the second or third aspects for selectively reducing oxides of nitrogen in an exhaust gas to dinitrogen using a nitrogenous reducing agent.

### BRIEF DESCRIPTION OF THE DRAWINGS

FIG. 1 is a graph showing NO_{X} conversion achieved by a catalyst prepared according to the first aspect of the present disclosure compared with (i) a catalyst prepared using a copper salt instead of iron sulphate; (ii) a catalyst prepared using an alternative iron salt; (iii) a catalyst prepared using a pre-exchanged iron-loaded zeolite; and (iv) a vanadium-based SCR catalyst.

FIG. 2 is a graph showing N₂O selectivity activity achieved by a catalyst prepared according to the first aspect of the present disclosure compared with (i) a catalyst prepared using a copper salt instead of iron sulphate; (ii) a catalyst prepared using an alternative iron salt; (iii) a catalyst prepared using a pre-exchanged iron-loaded zeolite; and (iv) a vanadium-based SCR catalyst.

FIG. 3 is a graph showing the CTE of a catalyst article according to the present disclosure.

FIG. 4 is a graph showing NO_{X} conversion achieved by catalysts prepared according to the first aspect of the present disclosure.

FIG. 5 is a graph showing N₂O selectivity activity achieved by a catalyst prepared according to the first aspect of the present disclosure.

### DETAILED DESCRIPTION

The present disclosure will now be described further. In the following passages different aspects/embodiments of the disclosure are defined in more detail. Each aspect/embodiment so defined may be combined with any other aspect/embodiment or aspects/embodiments unless clearly indicated to the contrary. In particular, any feature indicated as being preferred or advantageous may be combined with any other feature or features indicated as being preferred or advantageous.

Further, the term “comprising” as used herein can be exchanged for the definitions “consisting essentially of” or “consisting of”. The term “comprising” is intended to mean that the named elements are essential, but other elements may be added and still form a construct within the scope of the claim. The term “consisting essentially of” limits the scope of a claim to the specified materials or steps and those that do not materially affect the basic and novel characteristic(s) of the claimed invention. The term “consisting of” closes the claim to the inclusion of materials other than those recited except for impurities ordinarily associated therewith.

A crystalline molecular sieve is typically composed of aluminium, silicon, and/or phosphorus. A crystalline molecular sieve generally has a three-dimensional arrangement (e.g. framework) of repeating SiO₄, AlO₄, and optionally PO₄, tetrahedral units that are joined by the sharing of oxygen atoms. A small pore molecular sieve has a maximum ring size of eight tetrahedral atoms.

The term “H⁺-form” in relation to a molecular sieve refers to a molecular sieve having an anionic framework wherein the charge of the framework is counterbalanced by protons (i.e. H⁺ cations).

The term “NH₄⁺ form” in relation to a molecular sieve refers to a molecular sieve having an anionic framework wherein the charge of the framework is counterbalanced by ammonium cations (NH₄⁺ cations).

When the crystalline small pore molecular sieve has an aluminosilicate framework, then the molecular sieve is preferably a zeolite.

The small pore molecular sieve may have a Framework Type selected from the group of Framework Types consisting of ACO, AEI, AEN, AFN, AFT, AFX, ANA, APC, APD, ATT, CDO, CHA, DDR, DFT, EAB, EDI, EPI, ERI, GIS, GOO, IHW, ITE, ITW, KFI, LEV, LTA, MER, MON, NSI, OWE, PAU, PHI, RHO, RTH, SAT, SAV, SFW, SIV, THO, TSC, UEI, UFI, VNI, YUG, and ZON, and mixtures and/or intergrowths thereof. Preferably, the small pore molecular sieve has a Framework Type selected from the group of Framework Types consisting of AEI, AFT, AFX, CHA, DDR, ERI, KFI, LEV, LTA, SFW and RHO. More preferably, the small pore crystalline molecular sieve has a Framework Type that is AEI, AFX, CHA, LTA, ERI or AEI-CHA intergrowth. Most preferably, the small-pore molecular sieve has a CHA Framework Type.

Where the crystalline molecular sieve is a zeolite, the zeolite may have a silica-to-alumina ratio (SAR) of 5 to 200, preferably 5 to 100, more preferably 10 to 80. For example, the zeolite may have a silica-to-alumina ratio (SAR) of 5 to 30 or 10 to 30.

The crystalline small pore molecular sieve is preferably a powdered crystalline molecular sieve (i.e. in particulate form), wherein the particles comprise individual crystals, agglomerations of crystals or a combination of both. The crystalline molecular sieve may have a mean crystal size, as measured by scanning electron microscopy (SEM), of ≥ 0.5, preferably between about 0.5 and about 15 µm, such as about 0.5 to 10 µm, about 0.5 to about 5 µm, about 1 to about 5 µm, or about 2 to about 5 µm.

The powdered crystalline molecular sieve preferably has a D90 particle size of less than about 30 µm. The powdered crystalline molecular sieve preferably has a D99 particle size of less than about 50 µm. The terms “D90 particle size” and “D99 particle size” as used herein refer to particle size distribution. A value for D90 particle size corresponds to the particle size value below which 90%, by volume, of the total particles in a particular sample lie. A value for D99 particle size corresponds to the particle size value below which 99%, by volume, of the total particles in a particular sample lie. The D90 and D99 particle sizes may be determined using a laser diffraction method (e.g. using a Malvern Mastersizer 2000).

If desired, prior to forming the plastic mixture in step a) of the method of the first aspect, the molecular sieve may undergo a particle size reduction treatment such as jet milling, wet milling or steam assisted jet-milling.

The components to be mixed together in step (a) of the first aspect may include two or more crystalline small pore molecular sieves in an H⁺ or NH₄⁺ form. Consequently, the resulting solid catalyst body formed in step (c) may comprise two or more different types of iron-loaded molecular sieve.

The iron sulphate may be iron (II) sulphate or iron (III) sulphate.

The iron sulphate may be combined with the other components forming the plastic mixture in a crystalline form.

The relative quantities of the molecular sieve and the iron sulphate employed in step (a) will depend on the targeted iron loading of the molecular sieve. Iron-loaded molecular sieve present in the solid body produced in step (c) may have an iron-loading of ≥ 0.1% to ≤ 10.0% by weight, preferably ≥ 0.1% and ≤ 7.0% by weight, more preferably ≥ 0.5% and ≤ 5.0% by weight (based on the total weight of the iron loaded molecular sieve).

In particular, wherein the crystalline small pore molecular sieve is a zeolite, the relative quantities of the molecular sieve, and iron sulphate employed in step (a) may be selected to provide a solid catalyst body comprising an iron-loaded zeolite having an iron to aluminium ratio in the range 0.03 to 0.6, preferably in the range 0.05 to 0.5, for example 0.1 to 0.4, more preferably in the range 0.1 to 0.2.

The term “aqueous solvent” as used herein refers to a solvent that contains water. Preferably, the aqueous solvent consists essentially of water. That is the aqueous solvent contains water but may also contain minor non-aqueous (e.g. organic or inorganic) impurities. The water may be deionised or demineralised water.

The plastic mixture formed in step (a) has a solids content of at least 50 wt%, preferably at least 60 wt%. By “solids content” it is meant the proportion of solid material present in the plastic mixture based on the total weight of the mixture. In particular, the plastic mixture may take the form of a paste. The solids content of the mixture is preferably in the range 60 to 80 wt%, more preferably in the range 70 to 80 wt%. For example, the solids content of the mixture may be about 75 wt%.

The inorganic matrix component may comprise an inert filler (also referred to as a permanent binder) which provides structural integrity and/or porosity to the final solid catalyst body. In the course of calcining, the inorganic matrix component may form sinter bridges to provide stiffness and mechanical strength in the solid catalyst body. Some inorganic matrix components can also contribute desirable properties to assist in manufacture. For example, clays are inherently plastic so their inclusion in the mixture formed in step (a) may enable or promote a desired level of plasticity.

Preferably, the inorganic matrix component comprises an alumina precursor, such as boehmite or bayerite, which forms alumina upon calcination. The inorganic matrix component preferably comprises boehmite.

Alternatively or additionally, the inorganic matrix component may comprise silica or a silica pre-cursor, for example, colloidal silica, silanes or polysiloxanes.

Alternatively or additionally, the inorganic matrix component may comprise a clay. Suitable clays include bentonites, fire clay, attapulgite, fullers earth, sepiolite, hectorite, smectite, kaolin, diatomaceous earth and mixtures of any two or more thereof.

Optionally, the components to be mixed together in step (a) may further include inorganic fibres. Suitable inorganic fibres may be selected from the group consisting of carbon fibres, glass fibres, metal fibres, boron fibres, alumina fibres, silica fibres, silica-alumina fibres, silicon carbide fibres, potassium titanate fibres, aluminium borate fibres and ceramic fibres. Advantageously, inorganic fibres can improve the mechanical robustness of the calcined product.

Organic auxiliary agents are used to improve processing or to introduce desirable attributes to the final solid catalyst body but are burnt out during the calcination step. Such materials can improve processing plasticity and/or introduce porosity in the solid catalyst body. Organic auxiliary agents suitable for use in step (a) of the first aspect may comprise at least one of acrylic fibres (extrusion aid and pore former), a cellulose derivative (plasticizer and/or drying aid), other organic plasticizers (e.g. polyvinyl alcohol (PVA) or polyethylene oxide (PEO)), a lubricant (extrusion aid) and a water-soluble resin.

In some embodiments, further catalytically active materials may be incorporated into the plastic mixture formed in step (a), for example, where it is desired that the catalyst article is multi-functional (i.e. performs more than one catalytic function).

The relative quantitative proportions of the components used in step (a) may be selected such that the plastic mixture has the required solids content and such that the solid catalyst body, after the organic auxiliary agent is burnt out, contains 55 to 85 weight%, preferably 60 to 85 weight% of iron-loaded molecular sieve and 20 to 40 % by weight of inorganic matrix component (based on total weight of the solid catalyst body). The selection of appropriate quantities of starting materials is well within the capabilities of the skilled person. Preferably, the relative quantitative proportions of the components used in step (a) are selected such that the solid catalyst body produced in step (c) contains 60 to 85 weight% of iron-loaded molecular sieve and 20 to 40 wt.% of inorganic matrix component and 0 to 10 wt.% of inorganic fibres (based on total weight of the solid catalyst body).

The plastic mixture formed in step (a) may, for example, comprise 25 to 70 wt.% crystalline small pore molecular sieve in an H⁺ or NH₄⁺ form; 0.06 to 8 wt.% iron sulphate; 12 to 33 wt.% inorganic matrix component; 0 to 8 wt.% inorganic fibres; and up to 15 wt% organic auxiliary agent (based on total weight of the plastic mixture).

In step (a), the plastic mixture is formed by mixing together the components. The components may be mixed together in any order. Preferably, the mixture is substantially uniform, that is, the distribution of components throughout the mixture is substantially even. The components may be mixed by any suitable method. Preferably, the components are mixed by kneading.

Optionally, the pH of the plastic mixture may be adjusted by the addition of an acid or a base.

Step (a) may be carried out at ambient temperature. Preferably, step (a) is carried out at a temperature in the range 10 to 30° C. For example, step (a) may be carried out at a temperature in the range 18 to 28° C.

A particular advantage of the present invention is that the plastic mixture formed in step a) may be used directly as an extrusion paste. Thus, the mixture formed in step a) may be employed directly in step b) without any additional processing steps.

In step (b), the mixture may be moulded via extrusion techniques well-known in the art. For example, the mixture may be moulded using an extrusion press or an extruder including an extrusion die.

Step (b) may be carried out at ambient temperature. Preferably, step (b) is carried out at a temperature in the range 10 to 35° C., preferably in the range 10 to 30° C. For example, step (b) may be carried out at a temperature in the range 18 to 28° C.

Most preferably steps (a) and (b) are both carried out at a temperature in the range 10 to 35° C., preferably 10 to 30° C., more preferably 18 to 28° C.

Preferably, the temperature of the plastic mixture does not exceed 35° C. prior to calcination in step (c). For example, the temperature of the plastic mixture may be maintained at ≤ 30° C., or ≤ 28° C. prior to calcination in step (c).

Preferably, the shaped article takes the form of a honeycomb monolith. The honeycomb body may have any convenient size and shape. Alternatively, the shaped article may take other forms, such as a plate or pellets.

The shaped article may undergo a drying process prior to calcination in step (c). Thus, the method of the first aspect may further comprise drying the shaped article formed in step (b) prior to carrying out step (c). Drying of the shaped article may be carried out, via standard techniques, including freeze drying and microwave drying (for example, see WO2009/080155).

In step (c) of the first aspect, the (optionally dried) shaped article formed in step (b) undergoes calcination to form the solid catalyst body. The term “calcine” or “calcination” refers to a thermal treatment step. Calcination causes solidification of the shaped article by removal of any remaining solvent as well as the removal (e.g. by burning) of the organic auxiliary agent.

Calcination of the shaped article may be carried out via techniques well known in the art. In particular, calcination may be carried out statically or dynamically (for example, using a belt furnace).

Where the shaped article takes the form of a honeycomb monolith, a flow-through calcination technique may be employed, where heated gas is directed through the channels of the honeycomb.

Preferably, calcination step (c) is carried out at temperatures in the range 500 to 900° C., preferably 600 to 800° C.

Preferably, the shaped article is calcined for up to 5 hours, preferably 1 to 3 hours.

The calcination carried out in step (c) may comprise multiple thermal treatment steps, for example, the shaped article may be subjected to a first thermal treatment at a first temperature, and then subjected to a second thermal treatment at a second temperature.

Calcination may, for example, be carried out under a reducing atmosphere or an oxidizing atmosphere. Where multiple thermal treatment steps are employed, the different steps may be carried out under different atmospheres.

In the catalyst article according to the third aspect, the solid catalyst body may comprise: 60 to 85 wt% Fe-loaded small pore molecular sieve; 20 to 40 wt% matrix component; and 0 to 10 wt% inorganic fibres.

Advantageously, the extruded solid catalyst body of the catalyst article according to the third aspect has a CTE which is zero or positive at a temperature in the range 100 to 700° C. Where the CTE is positive it is preferably close to zero. The coefficient of thermal expansion (CTE) is a measure of how much a body expands or contracts on heating. Catalyst articles having a negative CTE may be susceptible to shrinkage.

Preferably, the solid catalyst body has a CTE in the range 0 to 5 × 10⁻⁶ /K at a temperature in the range 100° C. to 700° C. For example, the solid catalyst body has a CTE in the range 0.5 × 10⁻⁶ /K to 5 × 10⁻⁶ /K or in the range 0.5 × 10⁻⁶ /K to 4 × 10⁻⁶ /K at a temperature in the range 100° C. to 700° C.

The catalyst article according to the second or third aspects of the present disclosure may be employed for treating a flow of a combustion exhaust gas. That is, the catalyst article can be used to treat an exhaust gas derived from a combustion process, such as from an internal combustion engine (whether mobile or stationary), a gas turbine or a power plant (such as a coal or oil-fired power plant). In particular, the catalyst article may be used to treat an exhaust gas having a temperature in the range 300 to 600° C., more preferably 350 to 550° C., for example 400 to 500° C. A preferred application for the catalyst article of the present disclosure is in an exhaust system for treating an exhaust gas from a stationary source, such as a stationary internal combustion engine, a gas turbine or a power plant. In particular, the catalyst article may be employed as an SCR catalyst.

In some embodiments, for example, where it is desired that the catalyst article is multi-functional (i.e. it simultaneously performs more than one catalytic function), the method may include a further step of applying a catalytic washcoat to the catalyst article. Thus, the method of the first aspect may further comprise step (d) coating the solid catalyst body produced in step (c) with a composition comprising catalytically active material. For example, the composition may comprise an SCR catalyst and/or an ammonia slip catalyst (ASC). Such a washcoating step may be carried out according to processes well known in the art. Accordingly, the catalyst article according to the second or third aspects may further comprise a catalytic washcoat applied to the solid catalyst body.

The solid catalyst body may be configured as a flow through honeycomb monolith, wherein each channel is open at both ends and the channels extend through the entire axial length of the substrate. Alternatively, the solid catalyst body may be configured as a filter substrate, in which some channels are plugged at one end of the article and other channels are plugged at the opposite end. Such an arrangement has become known in the art as a wall-flow filter. The formation of a wall flow filter may be effected by means of suitable setting of the porosity of the solid catalyst body. Porosity of the final solid catalyst body may be controlled, for example, by the incorporation of organic pore-former components in the organic auxiliary agent employed in step (a) of the first aspect.

The catalyst article may be part of an emission gas treatment system wherein the catalyst article is disposed downstream of a source of a nitrogenous reductant.

### EXAMPLES

The present disclosure will now be further described with reference to the following examples, which are illustrative, but not limiting of the invention.

### Comparative Example A

Powdered H+-form SSZ-13 (CHA) zeolite was mixed with copper carbonate (CuCO₃.Cu(OH)₂), clay minerals, powdered synthetic boehmite alumina (Pural®SB) and glass fibres (CP160, obtainable from MUHLMEIER) and then admixed in an aqueous solution with a pH-value of 4 with carboxy methyl cellulose, a plasticizer/extrusion aid (Zusoplast, a mixture of oleic acid, glycols, acids and alcohols - a brand name of Zschimmer & Schwarz GmbH & Co KG) and a polyethylene oxide (Alkox® PEO) at room temperature to form a mouldable paste. The mouldable paste had a solids content of 64 wt.%. The quantitative proportions of the starting materials were selected such that final solid catalyst body contained 65% by weight of copper and zeolite (comprising a Cu/Al ratio of 0.16 based on total quantity of Cu and zeolite ), 25% by weight of γ—Al₂O₃ and clay minerals and 10% by weight of glass fibres.

The mouldable paste was extruded at 20° C. into a flow-through honeycomb having a circular cross-section of 1 inch diameter and a cell density of 500 cpsi (cells per square inch). The extruded honeycomb was freeze dried for several hours at 2mbar according to the method described in WO 2009/080155 and then calcined at a temperature of 600° C. in a lab scale muffle oven to form a solid catalyst body.

### Example 1

A mouldable paste was prepared according to the method employed in Comparative Example A except that, instead of a copper carbonate, crystalline iron (II) sulphate was employed. All other components employed in the paste preparation were the same. The quantitative proportions of the starting materials were selected to provide a final solid catalyst body containing 65% by weight of iron and zeolite (comprising a Fe/Al ratio of 0.16 based on total quantity of Fe and zeolite), 25% by weight of γ—Al₂O₃ and clay minerals and 10% by weight of glass fibres. The mouldable paste was then extruded into a flow-through honeycomb having the same shape and dimensions as that of Comparative Example A, which was then dried and calcined in the same way to form a solid catalyst body.

### Example 2

A mouldable paste was prepared according to the method employed in Example 1. The quantitative proportions of the starting materials were selected to provide a final solid catalyst body containing 65% by weight of iron and zeolite (comprising a Fe/Al ratio of 0.08 based on total quantity of Fe and zeolite), 25% by weight of γ—Al₂O₃ and clay minerals and 10% by weight of glass fibres. The mouldable paste was then extruded into a flow-through honeycomb having the same shape and dimensions as that of Comparative Example A, which was then dried and calcined in the same way to form a solid catalyst body.

### Example 3

A mouldable paste was prepared according to the method employed in Example 1. The quantitative proportions of the starting materials were selected to provide a final solid catalyst body containing 65% by weight of iron and zeolite (comprising a Fe/Al ratio of 0.24 based on total quantity of Fe and zeolite), 25% by weight of γ—Al₂O₃ and clay minerals and 10% by weight of glass fibres. The mouldable paste was then extruded into a flow-through honeycomb having the same shape and dimensions as that of Comparative Example A, which was then dried and calcined in the same way to form a solid catalyst body.

### Comparative Example B

A mouldable paste was prepared according to the method employed in Example 1 except that, instead of iron sulphate, iron citrate (ammonium iron (III) citrate) was employed in crystalline form. All other components employed in the paste preparation were the same. The quantitative proportions of the starting materials were selected to provide a final solid catalyst body containing 65% by weight of iron and zeolite (comprising a Fe/Al ratio of 0.16 based on total quantity of Fe and zeolite), 25% by weight of γ—Al₂O₃ and clay minerals and 10% by weight of glass fibres. The mouldable paste was then extruded into a flow-through honeycomb having the same shape and dimensions as that of Example 1, which was then dried and calcined in the same way to form a solid catalyst body.

### Comparative Example C

A commercially available extruded vanadium-based SCR having the same shape and dimensions as that of Example 1 was obtained.

### Comparative Example D

A mouldable paste was prepared according to the method employed in Example 1 except that, instead of the H+-form of the zeolite and iron sulphate, pre-exchanged iron-loaded SSZ-13 (CHA) zeolite having an Fe/Al ratio of 0.16 (which had been pre-prepared via a wet impregnation process) was employed. The quantitative proportions of the starting materials were selected to provide a final solid catalyst body containing 65% by weight of iron-loaded zeolite, 25% by weight of γ—Al₂O₃ and clay minerals and 10% by weight of glass fibres. The mouldable paste was then extruded into a flow-through honeycomb having the same shape and dimensions as that of Example 1, which was then dried and calcined in the same way to form a solid catalyst body.

### Comparative Example E

A mouldable paste was prepared according to method employed in Example 1 except that only the H+-form SSZ-13 (CHA) zeolite was employed without the addition of any metal salt. The quantitative proportions of the starting materials were selected to provide a final solid catalyst body containing 65% by weight of H⁺-type zeolite, 25% by weight of γ—Al₂O₃ and clay minerals and 10% by weight of glass fibres. The mouldable paste was then extruded into a flow-through honeycomb having the same shape and dimensions as that of Example 1, which was then dried and calcined in the same way to form a solid catalyst body.

### Catalyst Testing

Identical volume samples of Comparative Example A, B, C, D and Example 1 were tested in a synthetic catalytic activity test (SCAT) apparatus using the following inlet gas mixture at 500° C.: 300 ppm NO (0% NO₂), 300 ppm NH₃ (Ammonia to NOx ratio (ANR) = 1.0), 9.3% O₂, 7% H₂O, balance N₂, space velocity (SV) of 120000 h⁻¹.

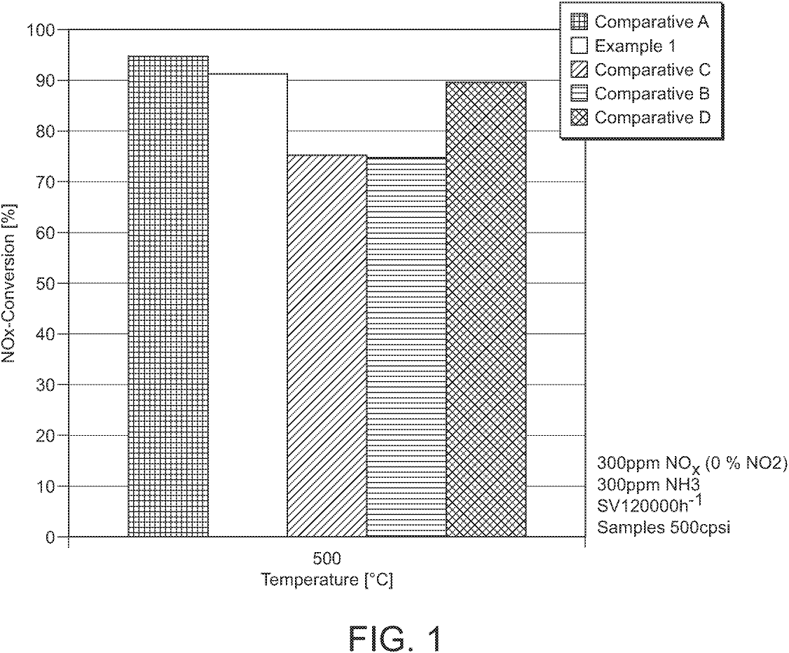

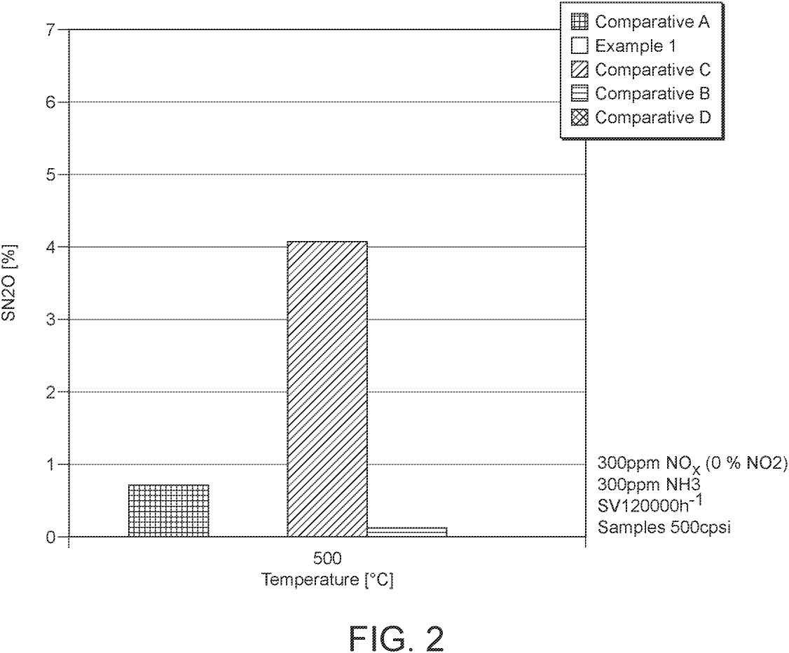

The results are shown in FIGS. 1 and 2.

FIG. 1 shows NO_{X} conversion achieved by each sample at 500° C., and FIG. 2 shows N₂O selectivity measured for each sample at 500° C.

As demonstrated by the data shown in FIGS. 1 and 2, Example 1 achieves similar NO_{X} conversion and improved N₂O selectivity compared to Comparative Example A, and improved NOx conversion and improved N₂O selectivity compared to Comparative Example B. In fact, no N₂O was detectable for the catalyst article prepared according to Example 1, whereas both Comparative Examples A and B displayed N₂O formation. Further, the performance of Example 1 is equivalent to that of Comparative Example D, indicating that the iron-loading achieved in Example 1 is similar to that of a pre-exchanged iron-loaded zeolite. Advantageously, the preparation of Example 1 required fewer process steps and reduced energy consumption compared to the overall preparation of Comparative Example D. Further still, the catalyst article of Example 1 achieves significantly improved NO_{X} and N₂O performance compared to the conventional vanadium-based catalyst (Comparative Example C).

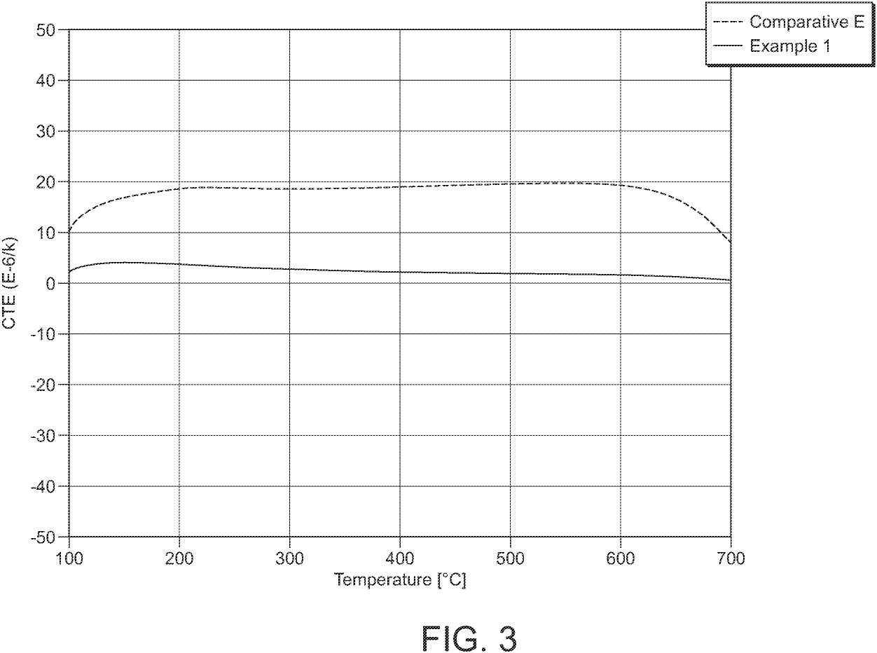

Samples of the catalyst articles prepared in Example 1 and Comparative Example E were subjected to CTE measurement over a range of temperatures using a dilatometer (L75 VS 1750° C. from Linseis). The results are shown in FIG. 3. As can be seen from FIG. 3, Example 1 has a positive CTE across the entire temperature range tested. Advantageously, the CTE of Example 1 is closer to zero than the CTE of Comparative Example E.

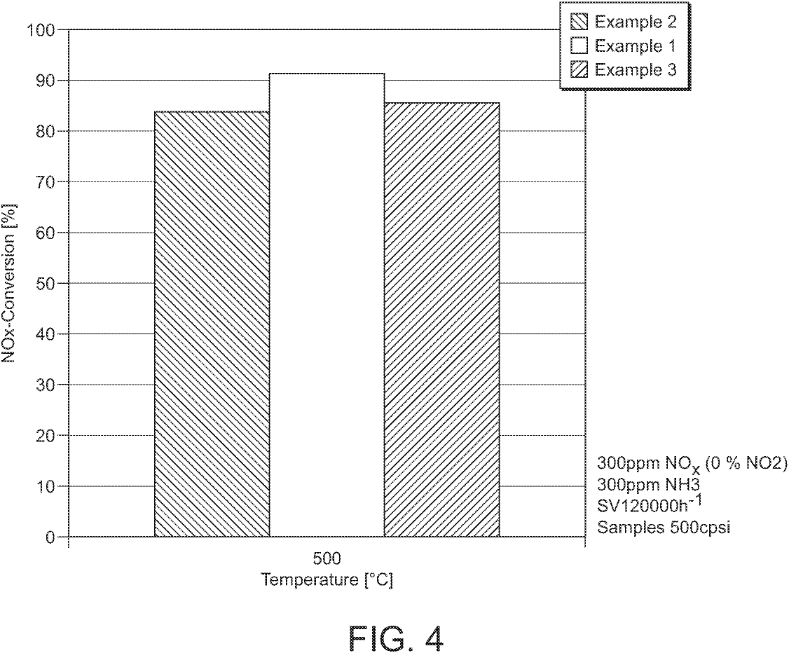

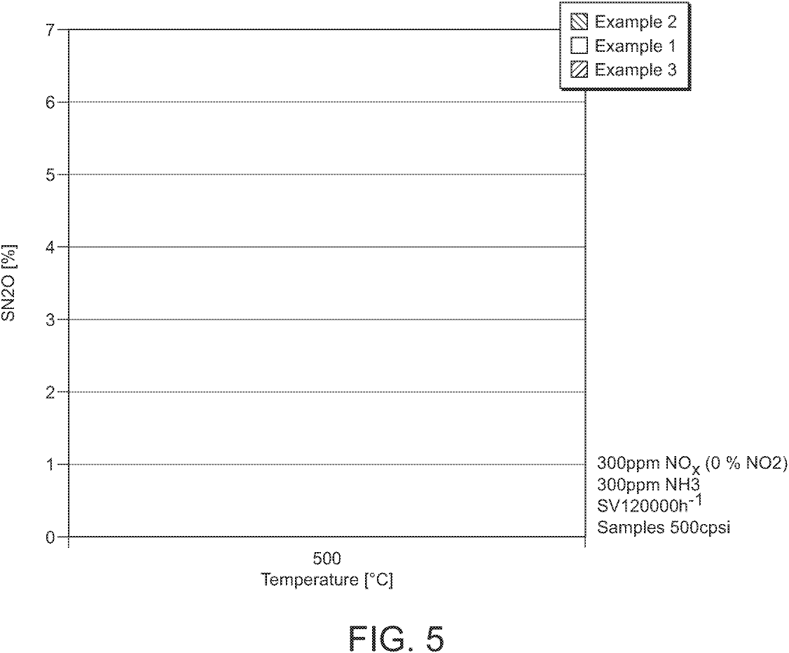

Identical volume samples of the catalyst articles prepared in Examples 1, 2 and 3 were tested in a synthetic catalytic activity test (SCAT) apparatus using the following inlet gas mixture at 500° C.: 300 ppm NO (0% NO₂), 300 ppm NH₃ (Ammonia to NOx ratio (ANR) = 1.0), 9.3% O₂, 7% H₂O, balance N₂, space velocity (SV) of 120000 h⁻¹. The results are shown in FIGS. 4 and 5.

FIG. 4 shows NO_{X} conversion achieved by each sample at 500° C. and FIG. 5 shows N₂O selectivity measured for each sample at 500° C.

As demonstrated by the data shown in FIGS. 4 and 5, all of the catalyst articles prepared in Examples 1, 2 and 3 achieve high NOx conversion and excellent N₂O selectivity. In fact, no N₂O was detectable for any of the catalyst articles prepared according to Examples 1, 2 or 3. Further, it can be seen from the data shown in FIG. 4 that the Fe/Al ratio of the iron-loaded zeolite may influence NOx conversion.

Further aspects and embodiments of the present disclosure are set out in the following numbered clauses:

Clause 1. A method for forming a catalyst article comprising:
(a) forming a plastic mixture by mixing together at least the following components:
   (i) a crystalline small pore molecular sieve in an H⁺ or NH₄⁺ form;
   (ii) iron sulphate;
   (iii) an inorganic matrix component;
   (iv) an organic auxiliary agent;
   (v) an aqueous solvent;
   wherein the mixture has a solids content of greater than 50 % by weight;
(b) moulding the plastic mixture into a shaped article; and
(c) calcining the shaped article to form a solid catalyst body.

Clause 2. A method as defined in clause 1 wherein in step (a) the components to be mixed together further include: (vi) inorganic fibres.

Clause 3. A method for forming a catalyst article comprising:
(a) forming a plastic mixture by mixing together the following components:
   (i) a crystalline small pore molecular sieve in an H⁺ or NH₄⁺ form;
   (ii) iron sulphate;
   (iii) an inorganic matrix component;
   (iv) an organic auxiliary agent;
   (v) an aqueous solvent;
   (vi) optional inorganic fibres;
   wherein the mixture has a solids content of greater than 50 % by weight;
(b) moulding the plastic mixture into a shaped article; and
(c) calcining the shaped article to form a solid catalyst body.

Clause 4. A method for forming a catalyst article consisting of:
(a) forming a plastic mixture by mixing together the following components:
   (i) a crystalline small pore molecular sieve in an H⁺ or NH₄⁺ form
   (ii) iron sulphate;
   (iii) an inorganic matrix component;
   (iv) an organic auxiliary agent;
   (v) an aqueous solvent;
   (vi) optional inorganic fibres;
   wherein the plastic mixture has a solids content of greater than 50 % by weight;
(b) moulding the plastic mixture into a shaped article; and
(c) calcining the shaped article to form a solid catalyst body;
wherein subsequent to step (b) and prior to step (c) the shaped article is optionally dried.

Clause 5. A method as defined in any preceding clause wherein the relative quantitative proportions of the components used in step (a) are selected such that the solid catalyst body formed in step (c) contains 55 to 85 weight% of iron-loaded molecular sieve and 20 to 40% by weight of inorganic matrix component and 0 to 10 wt.% of inorganic fibres.

Clause 6. A method as defined in any preceding clause wherein the relative quantitative proportions of the components used in step (a) are selected such that the solid catalyst body formed in step (c) contains 60 to 85 weight% of iron-loaded molecular sieve and 20 to 40 % by weight of inorganic matrix component and 0 to 10 wt.% of inorganic fibres.

Clause 7. A method as defined in any preceding clause wherein the plastic mixture formed in step (a) comprises 25 to 70 wt.% crystalline small pore molecular sieve in an H⁺ or NH₄⁺ form; 0.06 to 8 wt.% iron sulphate; 12 to 33 wt.% inorganic matrix component; 0 to 8 wt% inorganic fibres; and up to 15 wt% organic auxiliary agent (based on total weight of the plastic mixture).

Clause 8. A method as defined in any preceding clause wherein the crystalline small pore molecular sieve is a small pore zeolite.

Clause 9. A method as defined in clause 8 wherein the zeolite has a Framework Type selected from AEI, AFT, AFX, CHA, DDR, ERI, KFI, LEV, LTA, SFW and RHO.

Clause 10. A method as defined in any preceding clause wherein the crystalline small pore molecular sieve is a small pore zeolite having a Framework Type selected from CHA, AEI or AFX, LTA or ERI, preferably selected from CHA or AEI.

Clause 11. A method as defined in any preceding clause, wherein the crystalline molecular sieve is a zeolite having a silica-to-alumina ratio (SAR) of 5 to 200, 5 to 100, 10 to 80, or 5 to 30.

Clause 12. A method as defined in any preceding clause wherein the crystalline small pore molecular sieve is in particulate form and has D90 particle size of less than 30 µm.

Clause 13. A method as defined in any preceding clause wherein the crystalline small pore molecular sieve is in particulate form and has D99 particle size of less than 50 µm.

Clause 14. A method as defined in any preceding clause wherein component (i) comprises two or more small pore crystalline molecular sieves in an H⁺ or NH₄⁺ form.

Clause 15. A method as defined in any preceding clause wherein the iron sulphate is in crystalline form.

Clause 16. A method as defined in any preceding clause wherein the iron sulphate is iron (II) sulphate.

Clause 17. A method as defined in any of clauses 1 to 15 the iron sulphate iron (III) sulphate.

Clause 18. A method as defined in any preceding clause wherein the aqueous solvent consists essentially of water.

Clause 19. A method as defined in any preceding clause wherein the aqueous solvent is water.

Clause 20. A method as defined in any preceding clause wherein the plastic mixture formed in step (a) has a solids content of at least 60 wt%.

Clause 21. A method as defined in any preceding clause wherein the plastic mixture formed in step (a) has a solids content in the range 60 to 80 wt%, more preferably in the range 70 to 80 wt%.

Clause 22. A method as defined in any preceding clause wherein the inorganic matrix component comprises boehmite and/or bayerite, preferably boehmite.

Clause 23. A method as defined in any preceding clause wherein the inorganic matrix component comprises a clay.

Clause 24. A method as defined in clause 23 wherein the clay is selected from bentonites, fire clay, attapulgite, fullers earth, sepiolite, hectorite, smectite, kaolin, diatomaceous earth and mixtures of any two or more thereof.

Clause 25. A method as defined in any preceding clause, wherein in step (a) the components to be mixed together further include: (vi) inorganic fibres, and wherein the inorganic fibres comprise one or more of carbon fibres, glass fibres, metal fibres, boron fibres, alumina fibres, silica fibres, silica-alumina fibres, silicon carbide fibres, potassium titanate fibres, aluminium borate fibres, ceramic fibres.

Clause 26. A method as defined in any preceding clause wherein the organic auxiliary agent comprises at least one of acrylic fibres, a cellulose derivative, organic plasticizers, a lubricant and a water-soluble resin.

Clause 27. A method as defined in any preceding clause wherein in step (a) the components are mixed together by kneading.

Clause 28. A method as defined in any preceding clause wherein step (a) is carried out at ambient temperature.

Clause 29. A method as defined in any of clauses 1 to 28 wherein step (a) is carried out at a temperature in the range 10 to 35° C., in the range 10 to 30° C. or in the range 18 to 28° C.

Clause 30. A method as defined in any preceding clause wherein the plastic mixture formed in step a) is employed directly in step b) without any additional processing steps.

Clause 31. A method as defined in any preceding clause wherein step (b) is carried out via extrusion.

Clause 32. A method as defined in any preceding clause wherein step (b) is carried out at ambient temperature.

Clause 33. A method as defined in any of clauses 1 to 32 wherein step (b) is carried out at a temperature in the range 10 to 35° C., in the range 10 to 30° C. or in the range 18 to 28° C.

Clause 34. A method as defined in any preceding clause wherein the temperature of the plastic mixture does not exceed 35° C., preferably does not exceed 30° C., more preferably does not exceed 28° C. prior to calcination in step (c).

Clause 35. A method as defined in any preceding clause wherein the shaped article is a honeycomb monolith.

Clause 36. A method as defined in any preceding clause, which method further comprises drying the shaped article formed in step (b) prior to step (c).

Clause 37. A method as defined in any preceding clause wherein step (c) is carried out at a temperature in the range 500 to 900° C., preferably in the range 600 to 800° C.

Clause 38. A method as defined in any preceding clause wherein in step (c) calcination is carried out for a period of up to 5 hours, preferably 1 to 3 hours.

Clause 39. A method as defined in any preceding clause, wherein the solid catalyst body formed in step (c) comprises an iron-loaded small pore molecular sieve.

Clause 40. A method as defined in any preceding clause wherein the solid catalyst body formed in step (c) comprises an iron-loaded small pore molecular sieve which is catalytically active for SCR.

Clause 41. A catalyst article obtained or obtainable by the method as defined in any preceding clause.

Clause 42. A catalyst article comprising a solid catalyst body, which solid catalyst body comprises an iron-loaded small pore molecular sieve and has a coefficient of thermal expansion (CTE) which is zero or positive at a temperature in the range 100 to 700° C.

Clause 43. A catalyst article as defined in clause 42 wherein the solid catalyst body has a CTE in the range 0 to 5 × 10⁻⁶ /K, at a temperature in the range 100° C. to 700° C.

Clause 44. A catalyst as defined in clause 43 wherein the solid catalyst body has a CTE in the range 0.5 × 10⁻⁶ /K to 4 × 10⁻⁶ /K at a temperature in the range 100° C. to 700° C.

Clause 45. A catalyst article as defined in any of clauses 41 to 44, wherein the solid catalyst body comprises 60 to 85 wt% Fe-loaded small pore molecular sieve; 20 to 40 wt% matrix component; and 0 to 10 wt% inorganic fibres.

Clause 46. A catalyst article as defined in any of clauses 41 to 45 which is configured as a flow-through honeycomb monolith or a wall-flow filter.

Clause 47. A catalyst article as defined in any of clauses 41 to 46 which is catalytically active for SCR.

Clause 48. An exhaust system comprising: a source of nitrogenous reductant and an injector for injecting a nitrogenous reductant into a flowing exhaust gas, wherein the injector is disposed upstream from a catalyst article as defined in any of clauses 41 to 47.

Clause 49. A method of treating an exhaust gas, comprising contacting the exhaust gas with a catalyst article according to any of clauses 41 to 47.

Clause 50. A method as defined in clause 49 wherein the exhaust gas has a temperature in the range 300 to 600° C., more preferably 350 to 550° C., for example 400 to 500° C.

Clause 51. A method as defined in clause 49 or 50, wherein the exhaust gas is derived from a stationary source.

1. A method for forming a catalyst article comprising:
(a) forming a plastic mixture by mixing together at least the following components:
(i) a crystalline small pore molecular sieve in an H⁺ or NH₄⁺ form;
(ii) iron sulphate;
(iii) an inorganic matrix component;
(iv) an organic auxiliary agent;
(v) an aqueous solvent;
wherein the mixture has a solids content of greater than 50% by weight;
(b) moulding the plastic mixture into a shaped article; and
(c) calcining the shaped article to form a solid catalyst body
and wherein step (a) is carried out at a temperature in the range 10 to 35° C.

2. The method as claimed in claim 1 wherein in step (a) the components to be mixed together further include: (vi) inorganic fibres.

3. The method as claimed in claim 1 wherein the relative quantitative proportions of the components used in step (a) are selected such that the solid catalyst body formed in step (c) contains 60 to 85 weight% of iron-loaded molecular sieve, 20 to 40% by weight of matrix component and 0 to 10 wt.% of inorganic fibres.

4. The method as claimed in claim 1 wherein the crystalline small pore molecular sieve is a zeolite and the relative quantities of the molecular sieve, and iron sulphate employed in step (a) may be selected to provide a solid catalyst body comprising an iron-loaded zeolite having an iron to aluminium ratio in the range 0.03 to 0.6, in the range 0.05 to 0.5, in the range 0.1 to 0.4 or in the range 0.1 to 0.2.

5. The method as claimed in claim 1 wherein the crystalline small pore molecular sieve is a small pore zeolite having a Framework Type selected from CHA, AEI or AFX, LTA or ERI.

6. The method as claimed in claim 1 wherein the aqueous solvent is water.

7. The method as claimed in claim 1 wherein the plastic mixture formed in step (a) has a solids content of at least 60 wt%, preferably in the range 60 to 80 wt%, more preferably in the range 70 to 80 wt%.

8. The method as claimed in claim 1 wherein the inorganic matrix component comprises an alumina precursor and/or a clay.

9. The method as claimed in claim 1 wherein the iron sulphate is crystalline.

10. The method as claimed in claim 1 wherein step (a) is carried out at a temperature in the range 10 to 30° C. or in the range 18 to 28° C.

11. The method as claimed in as claimed in claim 1 wherein step (b) is carried out at a temperature in the range 10 to 35° C., in the range 10 to 30° C. or in the range 18 to 28° C.

12. The method as claimed in claim 1 wherein the plastic mixture formed in step a) is employed directly in step b) without any additional processing steps.

13. The method as claimed in claim 1 wherein the temperature of the plastic mixture does not exceed 35° C., preferably does not exceed 30° C., more preferably does not exceed 28° C., prior to calcination in step (c).

14. A catalyst article obtained or obtainable by the method as defined in claim 1.

15. A catalyst article comprising a solid catalyst body, which solid catalyst body comprises an iron-loaded small pore molecular sieve and has a coefficient of thermal expansion (CTE) which is zero or positive at a temperature in the range 100 to 700° C.

16. The catalyst article as claimed in claim 15 wherein the solid catalyst body has a CTE in the range 0 to 5 x 10⁻⁶ /K, at a temperature in the range 100° C. to 700° C.

17. The catalyst article as claimed in claim 15, wherein the solid catalyst body comprises:
a. 60 to 85 wt% iron-loaded small pore molecular sieve;
b. 20 to 40 wt% matrix component;
c. 0 to 10 wt% inorganic fibres.

18. An exhaust system comprising: a source of nitrogenous reductant and an injector for injecting a nitrogenous reductant into a flowing exhaust gas, wherein the injector is disposed upstream from a catalyst article as defined in claim 14.

19. An exhaust system comprising: a source of nitrogenous reductant and an injector for injecting a nitrogenous reductant into a flowing exhaust gas, wherein the injector is disposed upstream from a catalyst article as defined in claim 15.
